(19) United States
(12) Patent Application Publication
(10) Pub. No.: US 2016/0309091 A1
(43) Pub. Date: Oct. 20, 2016

(54) DISPLAY APPARATUS, DISPLAY CONTROL METHOD, AND IMAGE CAPTURING APPARATUS

(71) Applicant: CANON KABUSHIKI KAISHA, Tokyo (JP)

(72) Inventors: Yasuhito Kigure, Tokyo (JP); Seiji Matsunaga, Kawasaki-shi (JP); Yoshihiko Minato, Yokohama-shi (JP)

(21) Appl. No.: 15/096,733

(22) Filed: Apr. 12, 2016

(30) Foreign Application Priority Data
Apr. 16, 2015 (JP) 2015-083834
Apr. 16, 2015 (JP) 2015-083835

(51) Int. Cl. H04N 5/232; H04N 5/77; H04N 5/262; H04N 5/272

(52) U.S. Cl. CPC H04N 5/23293; H04N 5/23212; H04N 5/272; H04N 5/77; H04N 5/2628

(57) ABSTRACT

A display apparatus includes a memory controller, a focus-data acquisition unit, an image-data acquisition unit, and an image display unit. The memory controller causes a memory to store a target focus position, which is a focus position serving as a target and used when image capturing is performed by the image capturing apparatus. The focus-data acquisition unit acquires in-use focus data indicating an in-use focus position being used in image capturing performed by the image capturing apparatus. The image-data acquisition unit acquires image data generated by the image capturing apparatus capturing an image of a subject using the in-use focus position. The image display unit superimposes the target focus position and the in-use focus position on a displayed image based on the image data and causes a display unit to display the target focus position and the in-use focus position.

### BACKGROUND OF THE INVENTION

1. Field of the Invention

The present invention relates to a display apparatus, a display control method, and an image capturing apparatus.

2. Description of the Related Art

Hitherto, a method is known in which when an image of a subject is to be captured using an image capturing apparatus such as a digital camera or a digital video camera, information regarding the position where focus is achieved is displayed on a display. Japanese Patent Laid-Open No. 2010-93422 discloses an image capturing apparatus that detects the distance to a subject during capturing of an image of the subject, and displays an image showing a relationship between the position of the subject in an optical-axis direction of the image capturing apparatus and the position where focus is achieved.

A display apparatus, a display control method, and an image capturing apparatus according to the present invention improve on the above-described points to realize easy focus adjustment.

### SUMMARY OF THE INVENTION

An aspect of the present invention is directed to a display apparatus. The display apparatus is connectable to an image capturing apparatus, and includes a memory controller, an in-use-focus-data acquisition unit, an image-data acquisition unit, and an image display unit. The memory controller is configured to cause a memory to store a target focus position input by a user, the target focus position being a focus position serving as a target and used when image capturing is performed by the image capturing apparatus. The in-use-focus-data acquisition unit is configured to acquire in-use focus data indicating an in-use focus position being used in image capturing performed by the image capturing apparatus. The image-data acquisition unit is configured to acquire image data generated by the image capturing apparatus capturing an image of a subject using the in-use focus position. The image display unit is configured to superimpose the target focus position and the in-use focus position on a displayed image based on the image data, and cause a display unit to display the target focus position and the in-use focus position.

Further features of the present invention will become apparent from the following description of exemplary embodiments with reference to the attached drawings.

### BRIEF DESCRIPTION OF THE DRAWINGS

FIG. 1 is a diagram illustrating the configuration of an image capturing system according to a first embodiment.

FIGS. 2A and 2B are diagrams illustrating focus adjustment images displayed by a display apparatus.

FIG. 3 is a block diagram illustrating the functional configuration of an image capturing apparatus.

FIG. 4 is a block diagram illustrating the functional configuration of the display apparatus.

FIGS. 5A and 5B are diagrams illustrating target-focus-position tables.

FIG. 6 is a diagram illustrating a focus adjustment image including a plurality of target-position images.

FIG. 7 is a diagram illustrating a focus adjustment image including a plurality of target-position images.

FIG. 8 is a flowchart illustrating a processing procedure performed in the display apparatus.

FIGS. 9A and 9B are diagrams illustrating focus adjustment images displayed by a display apparatus according to a second embodiment.

FIG. 10 is a diagram illustrating a target-focus-position table according to the second embodiment.

FIG. 11 is a flowchart illustrating a processing procedure performed in the display apparatus according to the second embodiment.

FIG. 12 is a diagram illustrating the configuration of an image capturing apparatus according to a third embodiment.

FIG. 13 is a flowchart illustrating the procedure of a target-focus-data recording process performed in a display apparatus according to a fourth embodiment.

FIG. 14 is a flowchart illustrating the procedure of a target-focus-data playback process performed in the display apparatus according to the fourth embodiment.

FIG. 15 is a flowchart illustrating a modification of the procedure of a target-focus-data playback process performed in the display apparatus according to the fourth embodiment.

FIG. 16 is a flowchart illustrating a playback process performed in a display apparatus according to a fifth embodiment.

### DESCRIPTION OF THE EMBODIMENTS

### First Embodiment

### Overview of Image Capturing System S

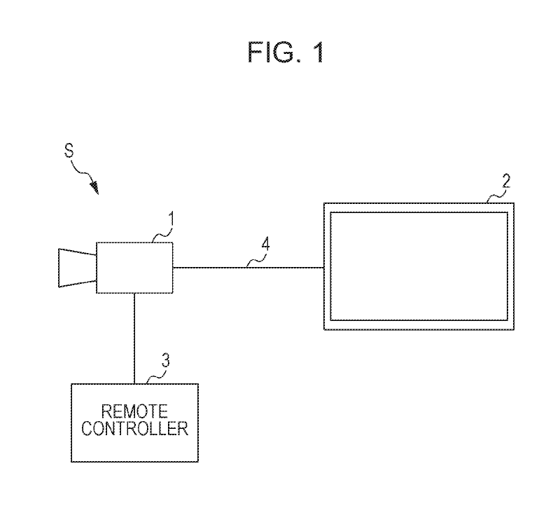

FIG. 1 is a diagram illustrating the configuration of an image capturing system S according to a first embodiment. The image capturing system S is, for example, a system used to shoot movies. The image capturing system S includes an image capturing apparatus 1, a display apparatus 2, and a remote controller 3.

The image capturing apparatus 1 is a video camera that generates image data of a moving image or still images by capturing images of a subject. The image capturing apparatus 1 is connected to the remote controller 3 via a cable or wireless connection. The user is able to adjust a position where focus is achieved (hereinafter referred to as “focus position”) using a focus ring provided at the image capturing apparatus 1 or the remote controller 3. The focus position is represented by the distance between a lens of the image capturing apparatus 1 and a subject for which focus is achieved.

The image capturing apparatus 1 generates an image signal including image data, and transmits the generated image signal to the display apparatus 2 via a transmission line 4. The transmission line 4 supports, for example, serial digital interface (SDI), and is composed of a coaxial cable capable of transmitting digital videos and digital voice. The image capturing apparatus 1 transmits, to the display apparatus 2, in-use focus data using an ancillary data area of an image signal supporting SDI. In-use focus data indicates an in-use focus position, which is a focus position being used for capturing images of a subject by the image capturing apparatus 1. The focus position indicates a depth position being in focus.

The display apparatus 2 is, for example, a liquid crystal display (LCD) or an organic electroluminescent (EL) display. The display apparatus 2 displays an image based on image data included in an image signal received from the image capturing apparatus 1. A user measures, for example, the distance to a subject at a rehearsal, and is able to set, in the display apparatus 2, a target focus position in accordance with the measured distance. The target focus position is a focus position serving as a target. The target focus position is set by the user before the time of actual image capturing such as a camera rehearsal. The display apparatus 2 displays a focus adjustment image showing the target focus position set by the user and an in-use focus position received from the image capturing apparatus 1.

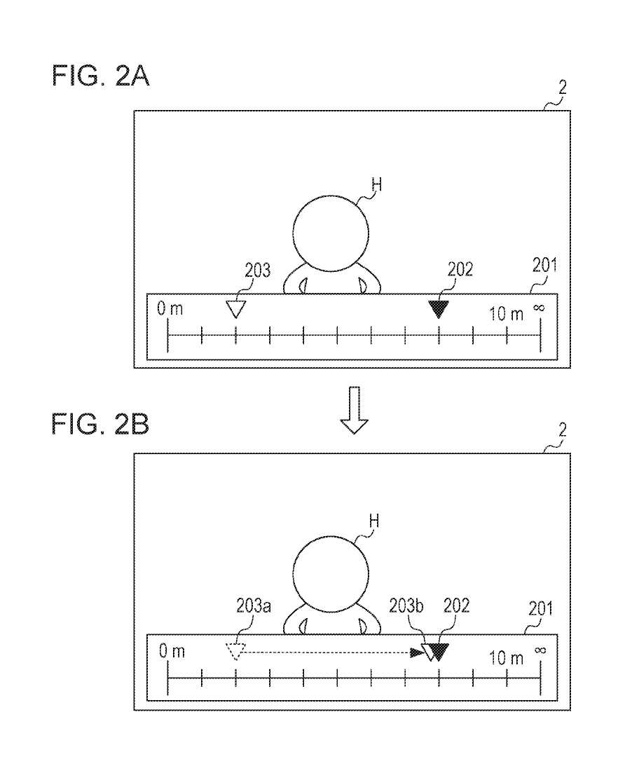

FIGS. 2A and 2B are diagrams illustrating focus adjustment images displayed by the display apparatus 2. As illustrated in FIG. 2A, the display apparatus 2 displays a focus adjustment image 201 together with a subject H. The focus adjustment image 201 is an image including a scale image, a target-position image 202 (a black triangle image), and an in-use position image 203 (a white triangle image). The scale image shows distances from 0 meters (m) to infinity (∞). The target-position image 202 shows a target focus position. The in-use position image 203 shows an in-use focus position.

A user is able to adjust the focus position of the image capturing apparatus 1 by operating the remote controller 3 while looking at the focus adjustment image 201 illustrated in FIG. 2A. When the focus position of the image capturing apparatus 1 is changed by the user operating the remote controller 3, data indicating the resulting in-use focus position is transmitted from the image capturing apparatus 1 to the display apparatus 2. The display apparatus 2 changes the position of the in-use position image 203 in accordance with the in-use focus position indicated by the received data. Specifically, as illustrated in FIG. 2B, the display apparatus 2 switches display of an in-use position image 203a indicating the in-use focus position used before focus position adjustment is performed by the user to display of an in-use position image 203b indicating the in-use focus position acquired after focus position adjustment is performed by the user.

As illustrated in FIG. 2B, the user is able to observe and recognize that adjustment of the in-use focus position to a target focus position is achieved, by confirming that the position of the in-use position image 203b substantially matches the position of the target-position image 202. In this manner, in the image capturing system S, the display apparatus 2 connected to the image capturing apparatus 1 displays a focus position set as a target, and the focus position being used by the image capturing apparatus 1. Thus, the user is able to easily adjust the focus position used in the image capturing apparatus 1 to a desired position.

In the following, the configuration of the image capturing apparatus 1 and the configuration of the display apparatus 2 will be described in detail.

### [Configuration of Image Capturing Apparatus 1]

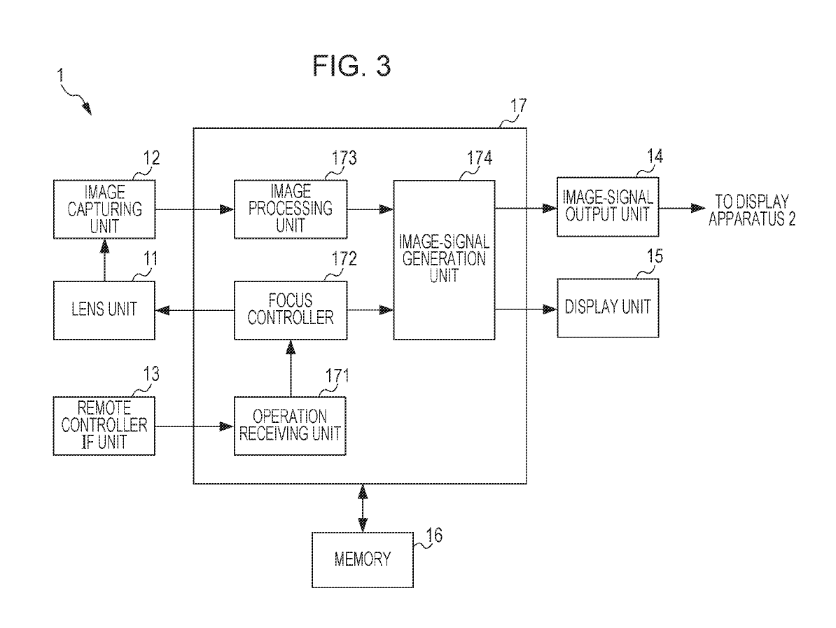

FIG. 3 is a block diagram illustrating the functional configuration of the image capturing apparatus 1. The image capturing apparatus 1 includes a lens unit 11, an image capturing unit 12, a remote controller interface (IF) unit 13, an image-signal output unit 14, a display unit 15, a memory 16, and a controller 17. The controller 17 includes an operation receiving unit 171, a focus controller 172, an image processing unit 173, and an image-signal generation unit 174.

The lens unit 11 includes one or more lenses, and a driving unit such as a motor (not shown) that moves the one or more lens along the optical-axis direction. In the lens unit 11, the driving unit is able to move the focus position by moving the position of the lens under control performed by the controller 17.

The image capturing unit 12 generates an imaging signal by photoelectrically converting an image of a subject, the image being formed on an imaging surface in accordance with light entering through the lens unit 11. The image capturing unit 12 is, for example, a charge-coupled device (CCD) or a complementary metal oxide semiconductor (CMOS) sensor.

The remote controller IF unit 13 is connected to the remote controller 3 via a cable or wirelessly, and receives operation data indicating the content of an operation input by a user using the remote controller 3. The remote controller IF unit 13 receives, from the remote controller 3, for example operation data used to specify a focus position to be used for image capturing, and notifies the operation receiving unit 171 of the received operation data.

The image-signal output unit 14 is an interface for outputting, to the display apparatus 2, an image signal including image data based on an imaging signal generated by the image capturing unit 12. The image-signal output unit 14 outputs an image signal supporting SDI and including, in an ancillary data area, in-use focus data indicating the focus position being used when the image capturing unit 12 generates an imaging signal. In addition, the image-signal output unit 14 outputs, to the display unit 15, an image signal including image data.

The display unit 15 is, for example, a liquid crystal display or an organic EL display. The display unit 15 displays an image based on an image signal input from the image-signal output unit 14.

The memory 16 is a storage medium such as a read-only memory (ROM) and a random-access memory (RAM). The memory 16 stores a program executed by the controller 17. In addition, the memory 16 temporarily stores various types of data generated by the controller 17.

The controller 17 is, for example, a central processing unit (CPU) or microprocessor, and operates as the operation receiving unit 171, the focus controller 172, the image processing unit 173, and the image-signal generation unit 174 by executing the program stored in the memory 16.

The operation receiving unit 171 receives operations input by a user through the remote controller IF unit 13. The operation receiving unit 171 receives, for example, operation data specifying a focus position, and notifies the focus controller 172 of the received operation data.

The focus controller 172 controls the driving unit of the lens unit 11 in accordance with operation data received by the operation receiving unit 171 and specifying a focus position, and as a result adjusts the focus position used by the image capturing apparatus 1. The focus controller 172 notifies the image-signal generation unit 174 of in-use focus data indicating the focus position acquired after the adjustment.

The image processing unit 173 generates image data in accordance with an imaging signal generated by the image capturing unit 12, and performs, on the generated image data, image processing such as color correction and gamma correction as well as compression processing. The image processing unit 173 outputs, to the image-signal generation unit 174, the image data on which the image processing and compression processing have been performed.

The image-signal generation unit 174 generates an image signal including in-use focus data input from the focus controller 172 and image data input from the image processing unit 173. Specifically, the image-signal generation unit 174 generates an image signal supporting SDI and including, in an ancillary data area, in-use focus data. The image-signal generation unit 174 outputs the generated image signal to the image-signal output unit 14 and the display unit 15.

### [Configuration of Display Apparatus 2]

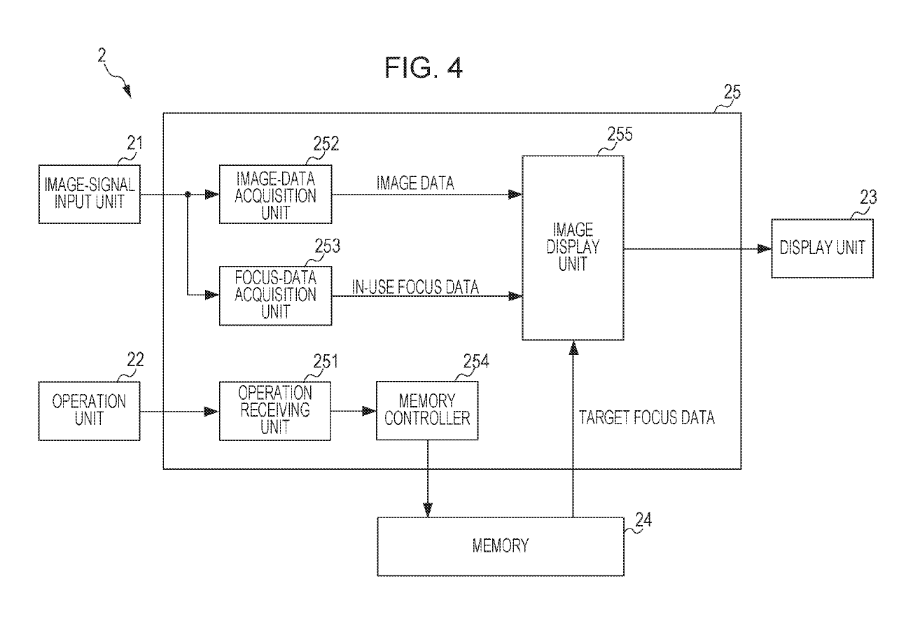

FIG. 4 is a block diagram illustrating the functional configuration of the display apparatus 2. The display apparatus 2 includes an image-signal input unit 21, an operation unit 22, a display unit 23, a memory 24, and a controller 25. The controller 25 includes an operation receiving unit 251, an image-data acquisition unit 252, a focus-data acquisition unit 253, a memory controller 254, and an image display unit 255.

The image-signal input unit 21 is an interface for receiving, as an input, an image signal output by the image-signal output unit 14. The image-signal input unit 21 decodes the received image signal, and outputs the decoded image signal to the image-data acquisition unit 252 and the focus-data acquisition unit 253.

The operation unit 22 is an input unit such as an operation panel, an operation button, or a touch panel, which is used by a user to perform operations for setting data in the display apparatus 2. The operation unit 22 notifies the operation receiving unit 251 of operation data indicating the content of an operation performed by a user. A user is able to perform, through the operation unit 22, operations such as starting of recording of, starting of playback of, and stopping of playback of target focus data. In addition, when a user starts recording of target focus data, the user may set, through the operation unit 22, target focus data, which is data indicating a target focus position used in the image capturing apparatus 1.

The display unit 23 displays an image based on image data output from the image display unit 255. The display unit 23 is, for example, a liquid crystal display or an organic EL display.

The memory 24 is a storage medium such as a ROM and a RAM. The memory 24 stores a program executed by the controller 25. In addition, the memory 24 temporarily stores various types of data output by the controller 25. For example, the memory 24 stores target focus data input by a user through the operation unit 22.

The controller 25 is, for example, a CPU, and operates as the operation receiving unit 251, the memory controller 254, the image-data acquisition unit 252, the focus-data acquisition unit 253, and the image display unit 255 by executing the program stored in the memory 24.

The operation receiving unit 251 receives, through the operation unit 22, operation data indicating the content of an operation performed by a user. For example, upon receiving operation data used to start setting of target focus data input by a user, the operation receiving unit 251 notifies the memory controller 254 that setting of target focus data is to be started. Thereafter, the operation receiving unit 251 sequentially receives pieces of target focus data, and outputs the received pieces of target focus data to the memory controller 254. In addition, upon receiving an operation for starting or terminating a playback operation that causes the focus adjustment image 201 illustrated in FIG. 2A to be displayed or an operation for target-focus-data switching, the operation receiving unit 251 notifies the image display unit 255 of the content of such an operation.

The operation receiving unit 251 may receive, together with the target focus data, data indicating a time period elapsed from a reference time or time stamp (for example, a time at which a playback operation is started for the focus adjustment image 201). For example, the operation receiving unit 251 causes the display unit 23 to display a screen which allows a user to input data indicating an elapsed time period. After receiving data indicating an elapsed time period, the operation receiving unit 251 causes the display unit 23 to display a screen used to input target focus data, and receives target focus data, as an input, in association with the elapsed time period.

The image-data acquisition unit 252 acquires image data included in an image signal input from the image-signal input unit 21. That is, the image-data acquisition unit 252 acquires image data generated by the image capturing apparatus 1 capturing an image of a subject using the focus position corresponding to in-use focus data acquired by the focus-data acquisition unit 253. The image-data acquisition unit 252 outputs the acquired image data to the image display unit 255.

The focus-data acquisition unit 253 acquires in-use focus data included in an image signal input from the image-signal input unit 21. The focus-data acquisition unit 253 outputs the acquired in-use focus data to the image display unit 255.

The memory controller 254 causes the memory 24 to store a target focus position input from the operation receiving unit 251. The memory controller 254 causes the memory 24 to store a plurality of pieces of target focus data in association with the order in which the plurality of pieces of target focus data are used in image capturing performed by the image capturing apparatus 1.

For example, the memory controller 254 resets the serial number of target focus data to one upon receiving, from the operation receiving unit 251, a notification indicating that setting of the target focus data is to be started. Thereafter, every time the memory controller 254 receives target focus data from the operation receiving unit 251, the memory controller 254 causes the memory 24 to store the target focus data in association with a certain serial number. The memory controller 254 adds one to the serial number every time the memory controller 254 causes the memory 24 to store target focus data.

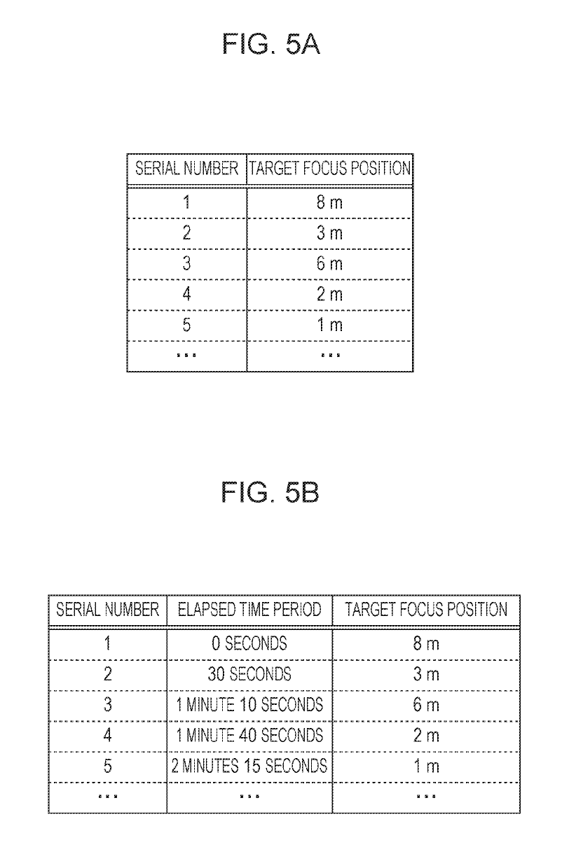

As a result, a target-focus-position table as illustrated in FIG. 5A is generated in the memory 24. In the target-focus-position table, serial numbers are associated with pieces of target focus data. Note that in the case where the operation receiving unit 251 receives, as an input, data indicating a time period elapsed from a reference time, the memory controller 254 may cause the memory 24 to store, as illustrated in FIG. 5B, the time period elapsed from the reference time so that the elapsed time period is associated with a target focus position.

Upon receiving, from the operation receiving unit 251, a notification indicating that playback of target focus data is to be started, the image display unit 255 generates the focus adjustment image 201 illustrated in FIG. 2A in accordance with in-use focus data input from the focus-data acquisition unit 253 and the target focus data stored in the memory 24. The image display unit 255 causes the display unit 23 to display the generated focus adjustment image 201. The image display unit 255 generates image data of a to-be-displayed image corresponding to the screen illustrated in FIG. 2A by superimposing the focus adjustment image 201 on the image based on image data input from the image-data acquisition unit 252, the focus adjustment image 201 including the target-position image 202 and the in-use position image 203.

The image display unit 255 updates the focus adjustment image 201 every time the image display unit 255 receives new in-use focus data from the focus-data acquisition unit 253. As a result, since the in-use position image 203 is moved in the focus adjustment image 201 in response to a change made to the focus position by a user as illustrated in FIG. 2B, the user is able to grasp in real time the focus position being used.

The image display unit 255 may switch the target-position image 202 included in the focus adjustment image 201 to another target-position image 202 in response to a target change operation performed by a user and input through the operation unit 22. For example, after displaying a target-position image 202 corresponding to a serial number of 1, when the operation receiving unit 251 receives a target change operation, the image display unit 255 deletes the target-position image 202 corresponding to a serial number of 1, and generates a focus adjustment image 201 including a target-position image 202 corresponding to a serial number of 2.

The image display unit 255 may also cause the display unit 23 to display a plurality of target focus positions in association with information indicating the order in which the target focus positions are used. For example, the image display unit 255 causes serial numbers to be displayed near a plurality of respective target-position images 202, the serial numbers being stored in the memory 24 in association with target focus positions.

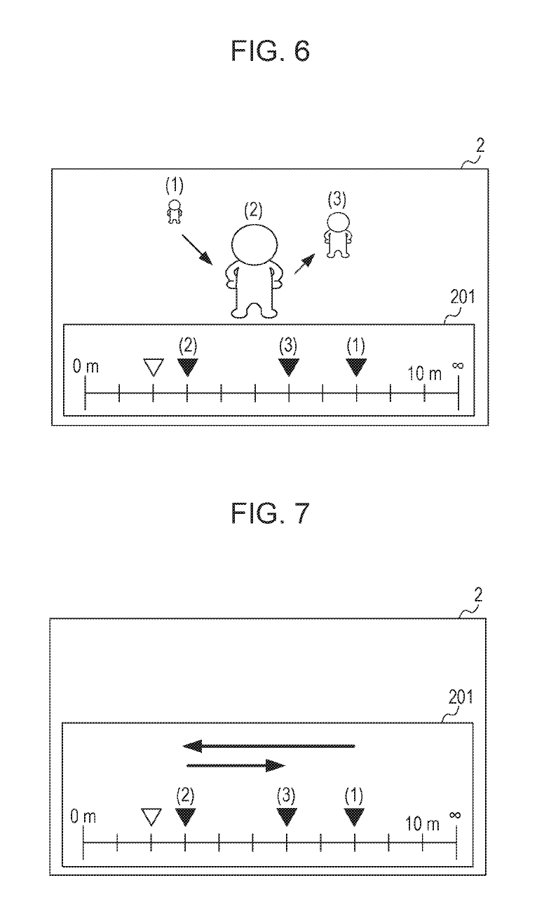

FIG. 6 is a diagram illustrating a focus adjustment image 201 including a plurality of target-position images 202. In FIG. 6, target-position images 202 are displayed that correspond to three focus positions (8 m, 3 m, and 6 m) having serial numbers of 1 to 3 among a plurality of target focus positions included in the target-focus-position table illustrated in FIG. 5A or 5B. In this manner, the image display unit 255 may cause the display unit 23 to display target focus positions the number of which has been set by a user in advance, among the plurality of target focus positions included in the target-focus-position table.

In FIG. 6, numbers (1), (2), and (3) indicating the order in which the target focus positions are used are displayed above the respective target-position images 202. A user is able to grasp, during image capturing, that the focus position needs to be changed in the order indicated by the numbers. For example, while a user is capturing images using a set focus position of 8 m, which is the first target focus position, the user is thus able to grasp that next the focus position needs to be changed to 3 m. Consequently, it is possible to promptly change the focus position at a timing at which the scene being captured is switched to the next scene.

The image display unit 255 may display, near the target-position images 202 as illustrated in FIG. 7, arrows indicating the order in which the target focus position is switched from one to another. As a result, the user may grasp the direction in which the focus position is to be changed. In a case where the focus position is changed by the remote controller 3, the image display unit 255 is able to further improve ease of operation by displaying an arrow oriented in the same direction as the operation direction of the focus position.

In addition, among images that the display unit 23 is caused to display and that are based on a plurality of pieces of target focus data, the image display unit 255 may stop displaying a target position image that becomes included in a predetermined range from the position indicated by the in-use focus data, the target position image being an image based on target focus data. For example, suppose a case where a certain target-position image 202 among a plurality of target-position images 202 that the display unit 23 is caused to display stays within a predetermined range from the position of the in-use position image 203 for at least a certain time period. In this case, it is considered that the in-use focus position matches the target focus position, and the image display unit 255 deletes the target-position image 202. At the moment when deleting the target-position image 202 or after deleting the target-position image 202, the image display unit 255 may cause the display unit 23 to display a target-position image 202, which is the next-to-be-displayed target-position image. As a result, in the case where the image display unit 255 causes a plurality of target-position images 202 to be displayed, a user does not have to look at target-position images 202 unnecessary for the current operation, thereby further improving the ease of operation.

### [Processing Procedure in Display Apparatus 2]

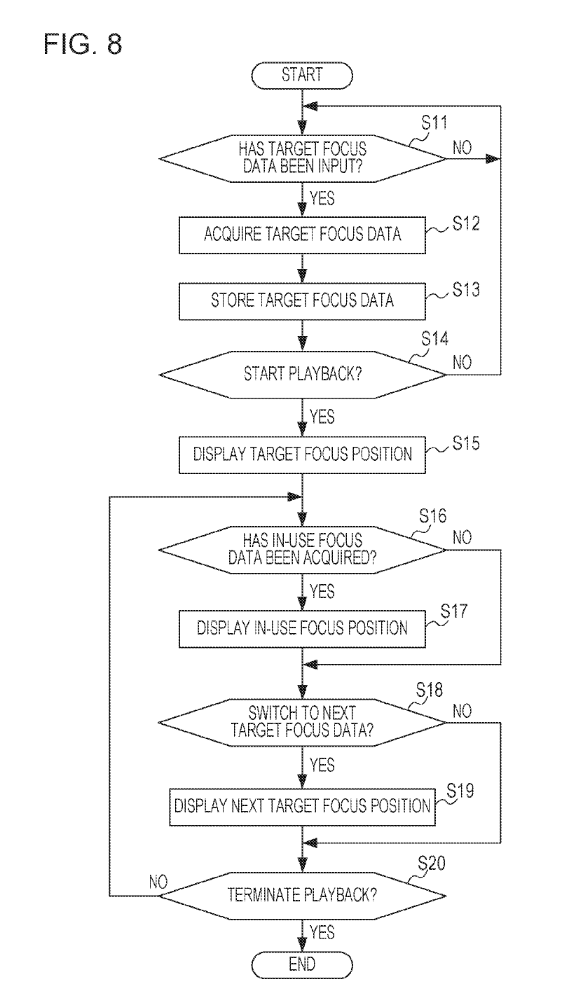

FIG. 8 is a flowchart illustrating a processing procedure performed in the display apparatus 2. Before a user starts capturing images in a state where a focus adjustment image 201 is displayed at the display apparatus 2, the operation receiving unit 251 receives target focus data as an input. Specifically, the operation receiving unit 251 monitors whether or not target focus data has been input (S11). In the case where target focus data has been input (Yes in S11), the operation receiving unit 251 acquires the input target focus data (S12). The operation receiving unit 251 causes the memory 24 to sequentially store pieces of input target focus data (S13).

The operation receiving unit 251 monitors whether or not an operation for starting a playback operation has been performed (S14), the playback operation being an operation for causing a focus adjustment image 201 to be displayed. While the operation for starting the playback operation is not performed (No in S14), the processing from S11 to S13 is repeated. In the case where it is determined in S14 that the operation for starting the playback operation has been performed (Yes in S14), the operation receiving unit 251 notifies the image display unit 255 that the playback operation is to be started. Upon receiving the notification indicating that the playback operation is to be started, the image display unit 255 reads out certain target focus data stored in the memory 24, and causes the display unit 23 to display a focus adjustment image 201 including a target-position image 202 corresponding to the read-out target focus data (S15).

Thereafter, the image display unit 255 monitors whether or not the focus-data acquisition unit 253 has acquired in-use focus data, which is superimposed on an image signal received by the image-signal input unit 21 (S16). In the case where the focus-data acquisition unit 253 has acquired the in-use focus data (Yes in S16), the image display unit 255 updates the focus adjustment image 201 being displayed on the display unit 23 to a focus adjustment image 201 including an in-use position image 203 corresponding to the acquired in-use focus data (S17). In the case where the focus-data acquisition unit 253 has not acquired the in-use focus data in S16 (No in S16), the process proceeds to S18.

Subsequently, the image display unit 255 confirms whether or not the target focus data needs to be switched to the next target focus data (S18). For example, in the case where the image display unit 255 has received, from the operation receiving unit 251, a notification indicating that an operation for switching the target focus data to the next target focus data is received (Yes in S18), the process proceeds to S19, and the image display unit 255 causes the display unit 23 to display an image based on the next target focus data (S19). In the case where, in S18, the image display unit 255 has not received, from the operation receiving unit 251, a notification indicating that the operation for switching the target focus data to the next target focus data is received (No in S18), the process proceeds to S20.

Note that in the case where elapsed time periods with respect to a reference time are stored in the memory 24 in association with pieces of target focus data and where, in S18, a time period elapsed from the time when the display unit 23 starts displaying the target-position image 202 matches a certain elapsed time period stored in the memory 24, the process may proceed to S19, and the image display unit 255 may cause the display unit 23 to display a target-position image 202 corresponding to the target focus position associated with the elapsed time period.

In the case where the image display unit 255 has received, from the operation receiving unit 251, a notification indicating that an operation for terminating the playback operation is received (Yes in S20), the image display unit 255 terminates the playback operation. In the case where the image display unit 255 has not received, from the operation receiving unit 251, a notification indicating that the operation for terminating the playback operation is received (No in S20), the process returns to S16. In S16, the image display unit 255 updates the focus adjustment image 201 every time the in-use focus data is updated.

### [Advantageous Effects According to First Embodiment]

As described above, in the image capturing system S according to the first embodiment, the memory controller 254 causes the memory 24 to store a target focus position, which is input by a user and which is a focus position serving as a target and used when image capturing is performed by the image capturing apparatus 1. When image capturing is performed using the image capturing apparatus 1, the image display unit 255 reads out the target focus position from the memory 24, and causes the display unit 23 to display a focus adjustment image 201 including an in-use position image 203 and a target-position image 202. The in-use position image 203 indicates the in-use focus position acquired from the image capturing apparatus 1 and used in image capturing. The target-position image 202 indicates the target focus position. As a result, the user becomes able to easily match the focus position of the image capturing apparatus 1 to a target focus position set in accordance with the distance to a subject, the distance having been measured in advance at the time of a rehearsal.

Note that the example is described above in which a user inputs target focus data before starting a playback operation; however, the timing at which target focus data is input is determined arbitrarily. For example, while the image display unit 255 is displaying a focus adjustment image 201, the operation receiving unit 251 may receive target focus data as an input. In this case, the memory controller 254 may add the input target focus data to the target-focus-position table stored in the memory 24, and may also update the target focus data specified by a user.

### Second Embodiment

The display apparatus 2 according to the first embodiment does not change the size of an image displayed on the display unit 23 even when a user matches an in-use focus position to a target focus position. In contrast to this, a display apparatus 2 according to a second embodiment differs from the display apparatus 2 according to the first embodiment in that when an in-use focus position becomes included in a predetermined range from a target focus position, the display apparatus 2 according to the second embodiment enlarges an image displayed on the display unit 23. The display apparatus 2 according to the second embodiment is useful in a case where a user wants to fine-adjust a focus position in a state where an in-use focus position is located near a target focus position. Note that the above-described predetermined range is, for example, set by a user through the operation unit 22.

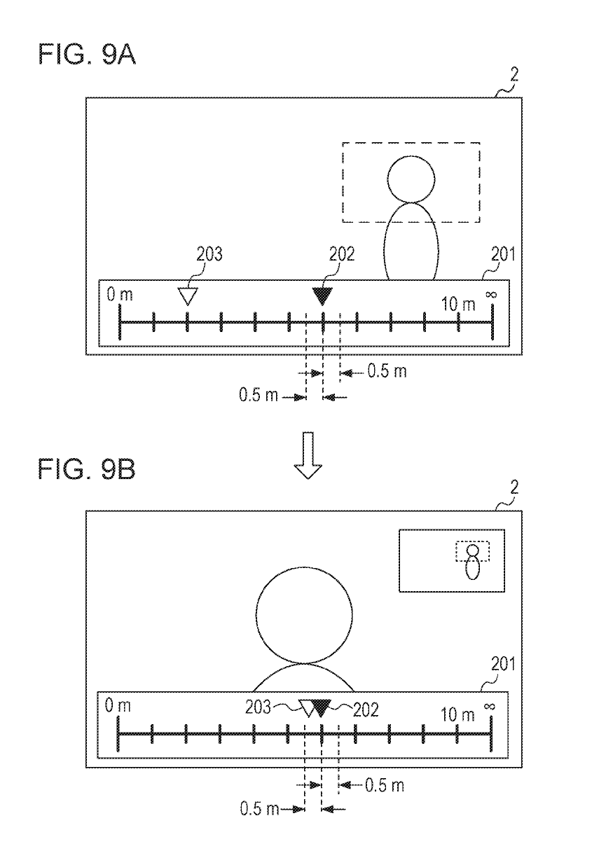

FIGS. 9A and 9B are diagrams illustrating focus adjustment images displayed by the display apparatus 2 according to the second embodiment. FIG. 9A illustrates a screen displayed when an in-use focus position is not included in a predetermined range (a target focus position±0.5 m in FIG. 9A) from the target focus position. The region encircled with broken lines in FIG. 9A is a region set in advance and to be enlarged in the image (hereinafter referred to as “enlargement region”).

FIG. 9B illustrates a screen displayed when the in-use focus position is included in the predetermined range from the target focus position. In this manner, the image display unit 255 according to the second embodiment enlarges a displayed image in a case where the in-use focus position is included in the predetermined range with respect to the target focus position, and causes the display unit 23 to display the enlarged image. As illustrated in FIG. 9B, the image display unit 255 causes a reduced-size image of the entirety of the displayed image to be displayed together with the enlarged image.

In accordance with the content of an operation performed by a user at the operation unit 22, the memory controller 254 may cause the memory 24 to store, in association with the target focus position, information used to specify the enlargement region. In addition, the memory controller 254 may also cause the memory 24 to store, in association with a time period elapsed from a reference time, information used to specify the enlargement region in the image.

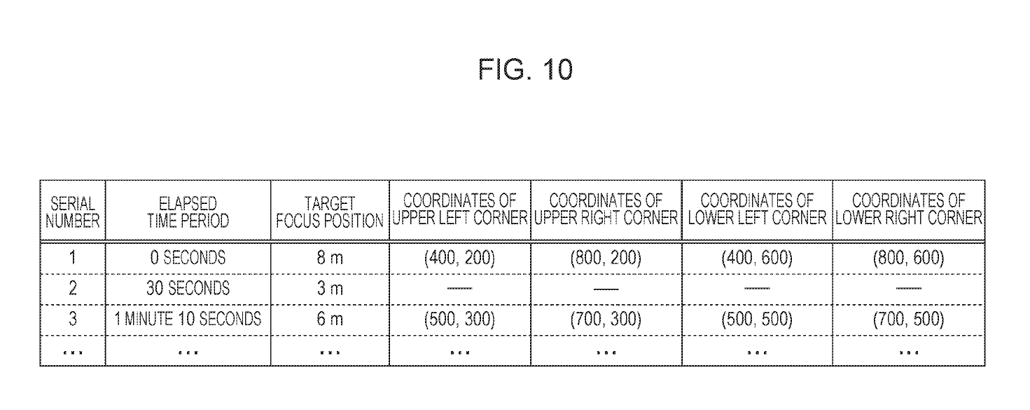

FIG. 10 is a diagram illustrating a target-focus-position table stored in the memory 24. In the target-focus-position table illustrated in FIG. 10, the order of target focus positions, time periods elapsed from the reference time, target focus positions, and the coordinates of regions to be displayed in an enlarged manner are associated with each other. For each region, the coordinates of the region are the coordinates of the four corners of the region. For the second target focus position, the coordinates of the four corners of a region to be displayed in an enlarged manner are not set. In such a case, the image display unit 255 does not enlarge the image displayed on the display unit 23 even when an in-use focus position becomes included in a predetermined range from the second target focus position.

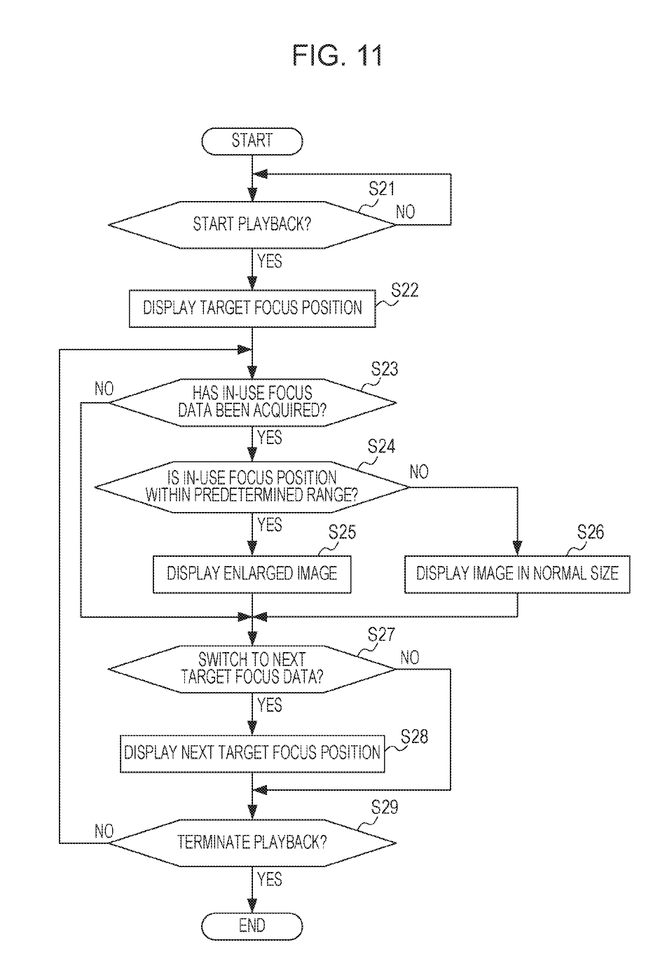

FIG. 11 is a flowchart illustrating a processing procedure performed in the display apparatus according to the second embodiment. FIG. 11 illustrates processing from the processing of S14 of the flowchart illustrated in FIG. 8. Since S21 to S23 and S27 to S29 of FIG. 11 correspond to S14 to S16 and S18 to S20 of FIG. 8, respectively, description thereof will be omitted.

Upon acquiring in-use focus data in S23, the image display unit 255 determines whether or not the in-use focus position indicated by the in-use focus data is included in a predetermined range with respect to a target focus position (S24). In the case where the in-use focus position is included in the predetermined range with respect to the target focus position (Yes in S24), the image display unit 255 enlarges an image based on image data input from the image-data acquisition unit 252, and causes the display unit 23 to display the resulting image (S25). Specifically, the image display unit 255 enlarges an image of an enlargement region stored in the memory 24 in association with the target focus position, and causes the resulting image to be displayed. In the case where the in-use focus position is not included in the predetermined range with respect to the target focus position (No in S24), the image display unit 255 does not enlarge the image based on the image data input from the image-data acquisition unit 252, and displays the image on the display unit 23 in a normal size (S26).

Note that, in S25, the image display unit 255 may enlarge an image, which is included in the displayed image, of a region corresponding to an elapsed time period acquired when the in-use focus position becomes included in the predetermined range with respect to the target focus position, and causes the resulting image to be displayed. For example, for each of the target focus positions, the memory 24 prestores the coordinates of a plurality of enlargement regions corresponding to a plurality of elapsed time periods in association with the target focus position. While the in-use focus position is included in the predetermined range with respect to the target focus position, the image display unit 255 changes, in accordance with an elapsed time period, a region to be enlarged in the image. As a result, in a case where the position of a subject changes while the target focus position is not changed, the image display unit 255 is able to enlarge an image of and around the subject and cause the display unit 23 to display the resulting image. Thus, a user may more easily fine-adjust the in-use focus position while looking at the subject's image displayed in an enlarged manner.

### [Advantageous Effects According to Second Embodiment]

As described above, in an image capturing system S according to the second embodiment, the image display unit 255 enlarges an image displayed on the display unit 23 in a case where an in-use focus position becomes included in a predetermined range from a target focus position. As a result, when an in-use focus position approaches a target focus position, a user is able to fine-adjust the in-use focus position while looking at a subject's image displayed in an enlarged manner, without performing an operation for performing enlarged display. Consequently, a user is able to increase the accuracy of focus position adjustment without performing a complicated operation.

### Third Embodiment

In the first embodiment and the second embodiment, the display apparatus 2 displays a target focus position and an in-use focus position. In contrast to this, a third embodiment differs from the first embodiment and the second embodiment in that an image capturing apparatus 1 displays a target focus position and an in-use focus position on the display unit 15.

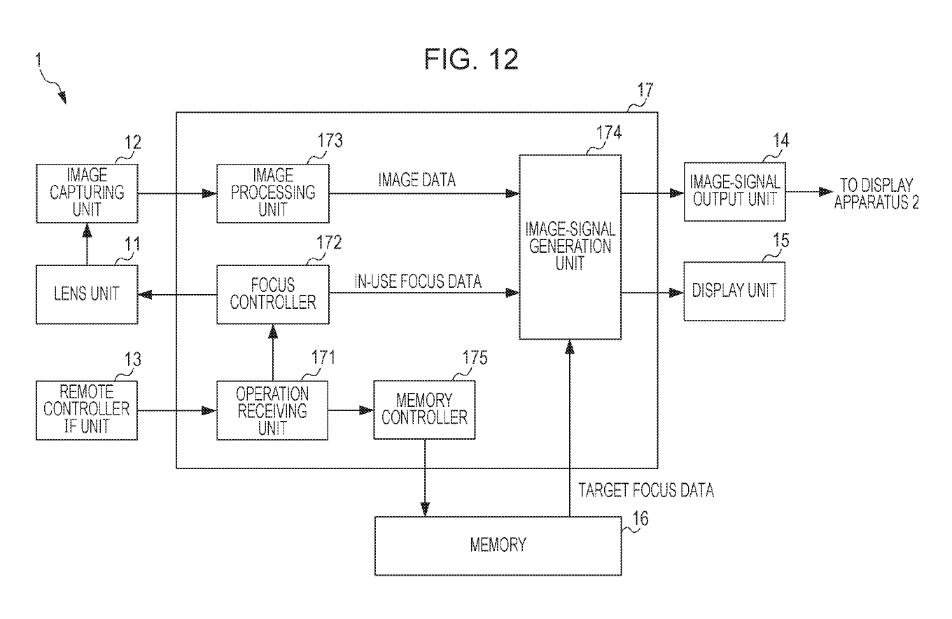

FIG. 12 is a diagram illustrating the configuration of an image capturing apparatus 1 according to the third embodiment. The image capturing apparatus 1 illustrated in FIG. 12 differs from the image capturing apparatus 1 illustrated in FIG. 3 in that the image capturing apparatus 1 illustrated in FIG. 12 includes a memory controller 175. In addition, the image capturing apparatus 1 illustrated in FIG. 12 differs from the image capturing apparatus 1 illustrated in FIG. 3 in that the image-signal generation unit 174 causes the display unit 15 to display not only an image based on image data but also a focus adjustment image 201, which is superimposed on the image based on the image data. The focus adjustment image 201 includes a target-position image 202 and an in-use position image 203, the target-position image 202 indicating a target focus position, the in-use position image 203 indicating an in-use focus position.

The memory controller 175 has substantially the same function as the memory controller 254 according to the first embodiment and the second embodiment. For example, the memory controller 175 causes the memory 16 to store target focus data input by a user through the remote controller IF unit 13. The memory 16 stores a target-focus-position table as illustrated in FIG. 5A, 5B, or 10. Similarly to the image display unit 255 according to the first embodiment and the second embodiment, the image-signal generation unit 174 sequentially reads out target focus positions stored in the memory 16, and causes the display unit 15 to display a target-position image 202 together with an in-use position image 203 based on in-use focus data input from the focus controller 172.

### [Advantageous Effects According to Third Embodiment]

As described above, the image capturing apparatus 1 according to the third embodiment is able to display, together with the focus position being used in image capturing, a target focus position input by a user. Consequently, without connecting the image capturing apparatus 1 to the display apparatus 2, a user becomes able to easily match the focus position of the image capturing apparatus 1 to a target focus position set in accordance with the distance to a subject, the distance having been measured in advance at the time of a rehearsal.

### Fourth Embodiment

In a display apparatus 2 according to a fourth embodiment, the image display unit 255 automatically records target focus data in synchronization with an operation performed to change the focus position by a user, and updates a target-position image 202. The configuration of an image capturing system S according to the fourth embodiment is substantially the same as the configuration illustrated in FIG. 1. The operation receiving unit 251 receives, through the operation unit 22, operation data indicating the content of an operation performed by a user. For example, upon receiving operation data used to start recording of target focus data input by a user, the operation receiving unit 251 notifies the memory controller 254 that recording of target focus data is to be started. In addition, upon receiving an operation for starting or terminating a playback operation that causes the focus adjustment image 201 illustrated in FIG. 2A to be displayed or an operation for target-focus-data switching, the operation receiving unit 251 notifies the image display unit 255 of the content of such an operation.

The image-data acquisition unit 252 acquires image data included in an image signal input from the image-signal input unit 21. That is, the image-data acquisition unit 252 acquires image data generated by the image capturing apparatus 1 capturing an image of a subject using a focus position corresponding to in-use focus data acquired by the focus-data acquisition unit 253. The image-data acquisition unit 252 outputs the acquired image data to the image display unit 255.

The focus-data acquisition unit 253 acquires in-use focus data included in an image signal input from the image-signal input unit 21. The focus-data acquisition unit 253 outputs the acquired in-use focus data to the memory controller 254 and the image display unit 255.

Upon receiving, from the operation receiving unit 251, a notification indicating that recording of target focus data is to be started, the memory controller 254 causes the memory 24 to store, in association with scene recognition information, in-use focus data (first focus data) as target focus data, the in-use focus data having been input from the focus-data acquisition unit 253. The memory controller 254 causes the memory 24 to store a plurality of pieces of target focus data in association with the order in which the plurality of pieces of target focus data are used in image capturing performed by the image capturing apparatus 1.

For example, the memory controller 254 resets the serial number of target focus data to one upon receiving, from the operation receiving unit 251, a notification indicating that recording of target focus data is to be started. Thereafter, every time the memory controller 254 receives in-use focus data from the focus-data acquisition unit 253 at predetermined time intervals, the memory controller 254 causes the memory 24 to store, in association with a certain serial number, the in-use focus data as target focus data. The memory controller 254 adds one to the serial number every time the memory controller 254 causes the memory 24 to store target focus data.

As a result, a target-focus-position table as illustrated in FIG. 5A is generated in the memory 24. In the target-focus-position table, serial numbers are associated with pieces of target focus data. As illustrated in FIG. 5B, the memory controller 254 may also cause the memory 24 to store, in association with a certain target focus position, a time period elapsed from a reference time (for example, a time at which recording of the target focus data is started).

In the case where the focus position being used in the image capturing apparatus 1 is the same for at least a time period corresponding to a predetermined value, the memory controller 254 may also cause the memory 24 to store, as target focus data, in-use focus data input from the focus-data acquisition unit 253. Specifically, the memory controller 254 monitors the value of in-use focus data input from the focus-data acquisition unit 253. In the case where the value of the in-use focus data is changed, the value acquired after the change is caused to be provisionally stored in the memory 24. After the memory 24 is caused to provisionally store the value acquired after the change, in the case where the value acquired after the change is not changed for at least the time period corresponding to the predetermined value, the memory controller 254 causes the memory 24 to store, in association with a serial number, the value caused to be provisionally stored, the value being stored as target focus data. After causing the memory 24 to provisionally store the value acquired after the change, in the case where the value acquired after the change is changed within a time period corresponding to a value lower than the predetermined value, the memory controller 254 deletes, from the memory 24, the value caused to be provisionally stored.

In addition, in the case where the focus position being used in the image capturing apparatus 1 is the same for at least the time period corresponding to the predetermined value, the memory controller 254 may also cause the memory 24 to store, in association with the focus position, the time period elapsed from a reference time to the setting time of the focus position. Specifically, in the case where the value of in-use focus data is changed, the memory controller 254 causes the memory 24 to provisionally store, in association with a time period elapsed from the reference time at which the value of the in-use focus data is changed, the value acquired after the change. After causing the memory 24 to provisionally store the value acquired after the change, the memory controller 254 causes the memory 24 to store, as target focus data, the value caused to be provisionally stored and the elapsed time period, in the case where the value acquired after the change is not changed for at least the time period corresponding to the predetermined value.

Upon receiving, from the operation receiving unit 251, a notification indicating that playback of target focus data is to be started, the image display unit 255 generates the focus adjustment image 201 illustrated in FIG. 2A in accordance with in-use focus data input from the focus-data acquisition unit 253 and the target focus data stored in the memory 24. The image display unit 255 causes the display unit 23 to display the generated focus adjustment image 201. The image display unit 255 generates image data of a to-be-displayed image corresponding to the screen illustrated in FIG. 2A by superimposing the focus adjustment image 201 on the image based on image data input from the image-data acquisition unit 252, the focus adjustment image 201 including the target-position image 202 and the in-use position image 203.

The image display unit 255 updates the focus adjustment image 201 every time the image display unit 255 receives new in-use focus data from the focus-data acquisition unit 253. As a result, since the in-use position image 203 is moved in the focus adjustment image 201 in response to a change made to the focus position by a user as illustrated in FIG. 2B, the user is able to grasp in real time the focus position being used.

The image display unit 255 may also cause the display unit 23 to display a plurality of target focus positions in association with information indicating the order in which the target focus positions are used. For example, the image display unit 255 causes serial numbers to be displayed near a plurality of respective target-position images 202, the serial numbers being stored in the memory 24 in association with target focus positions.

FIG. 6 is a diagram illustrating a focus adjustment image 201 including a plurality of target-position images 202. In FIG. 6, target-position images 202 are displayed that correspond to three focus positions (8 m, 3 m, and 6 m) having serial numbers of 1 to 3 among a plurality of target focus positions included in the target-focus-position table illustrated in FIG. 5A or 58B. In this manner, the image display unit 255 may cause the display unit 23 to display target focus positions the number of which has been set by a user in advance, among the plurality of target focus positions included in the target-focus-position table.

In FIG. 6, numbers (1), (2), and (3) indicating the order in which the target focus positions are used are displayed above the respective target-position images 202. The user is able to grasp, during image capturing, that the focus position needs to be changed in the order indicated by the numbers. For example, while a user is capturing images using a set focus position of 8 m, which is the first target focus position, the user is thus able to grasp that next the focus position needs to be changed to 3 m. Consequently, it is possible to promptly change the focus position at a timing at which the scene being captured is switched to the next scene.

In addition, after an in-use focus position indicated by in-use focus data becomes included in a predetermined range from a target focus position indicated by target focus data and displayed on the display unit 23, in a case where the in-use focus position is changed and not included in the predetermined range, the image display unit 255 may also causes the display unit 23 to display a target-position image 202 corresponding to the next target focus data according to the order. As a result, a user does not have to perform an operation for switching to the next target focus data, and the target-position image 202 corresponding to the next target focus data is displayed without performing the operation, thereby improving the ease of operation.

In addition, among images that the display unit 23 is caused to display and that are based on a plurality of pieces of target focus data, the image display unit 255 may stop displaying a target position image that becomes included in a predetermined range from the position indicated by the in-use focus data, the target position image being an image based on target focus data. For example, suppose a case where a certain target-position image 202 among a plurality of target-position images 202 that the display unit 23 is caused to display stays within a predetermined range from the position of the in-use position image 203 for at least a certain time period. In this case, it is considered that the in-use focus position matches the target focus position, and the image display unit 255 deletes the target-position image 202. At the moment when deleting the target-position image 202 or after deleting the target-position image 202, the image display unit 255 may cause the display unit 23 to display a target-position image 202, which is the next-to-be-displayed target-position image. As a result, in the case where the image display unit 255 causes a plurality of target-position images 202 to be displayed, a user does not have to look at target-position images 202 unnecessary for the current operation, thereby further improving the ease of operation.

### [Procedure of Recording Process in Display Apparatus 2]

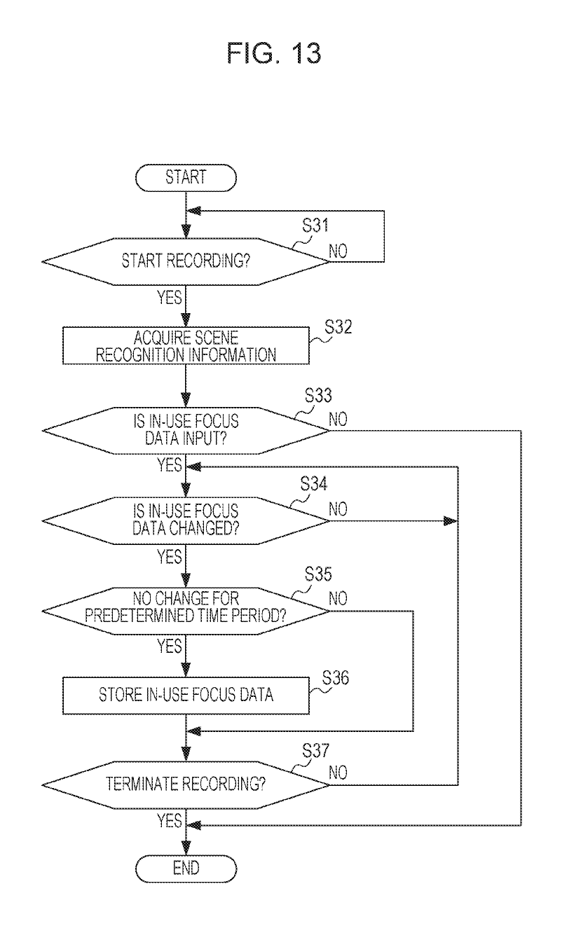

FIG. 13 is a flowchart illustrating the procedure of a target-focus-data recording process performed in the display apparatus 2. In an idle state, the operation receiving unit 251 monitors whether or not an operation for starting recording of target focus data is performed (S31). In the case where the operation receiving unit 251 detects that the operation for starting recording of target focus data has been performed (Yes in S31), the operation receiving unit 251 causes, using the image display unit 255, the display unit 23 to display an operation screen used to receive scene recognition information, and acquires scene recognition information input by a user (S32). For example, the image display unit 255 causes the display unit 23 to display a screen used to select a piece of scene recognition information from among a plurality of pieces of scene recognition information stored in the memory 24, and causes the display unit 23 to display an image based on target focus data corresponding to the selected piece of scene recognition information.

Subsequently, the operation receiving unit 251 notifies the memory controller 254 that recording is to be started and of the piece of scene recognition information input by a user. Upon receiving a notification indicating that recording is to be started, the memory controller 254 causes the memory 24 to store the scene recognition information acquired from the operation receiving unit 251, and starts recording of in-use focus data input from the focus-data acquisition unit 253.

Specifically, when recording of in-use focus data is started, the memory controller 254 confirms whether or not in-use focus data is input from the focus-data acquisition unit 253 (S33). In the case where the memory controller 254 confirms that in-use focus data is input (Yes in S33), thereafter the memory controller 254 acquires in-use focus data at predetermined time intervals. In the case where the memory controller 254 confirms that in-use focus data is not input over a predetermined time period (No in S33), the memory controller 254 terminates the recording process.

Upon acquiring in-use focus data, the memory controller 254 confirms whether or not the acquired in-use focus data is changed from the preceding in-use focus data, which is acquired immediately before the acquired in-use focus (S34). In the case where the in-use focus data acquired by the memory controller 254 is the first in-use focus data after start of the recording and the case where the acquired in-use focus data is changed from the preceding in-use focus data (Yes in S34), the memory controller 254 confirms whether or not the in-use focus data acquired after the change is the same for at least a time period corresponding to a predetermined value (S35).

In the case where the in-use focus data acquired after the change is the same for at least the time period corresponding to the predetermined value (Yes in S35), the memory controller 254 causes the memory 24 to store the in-use focus data in association with the scene recognition information (S36). The memory controller 254 monitors whether an operation for terminating the recording is performed (S37). Until the operation for terminating the recording is detected, the processing from S34 to S36 is repeated.

### [Procedure of Playback Process in Display Apparatus 2]

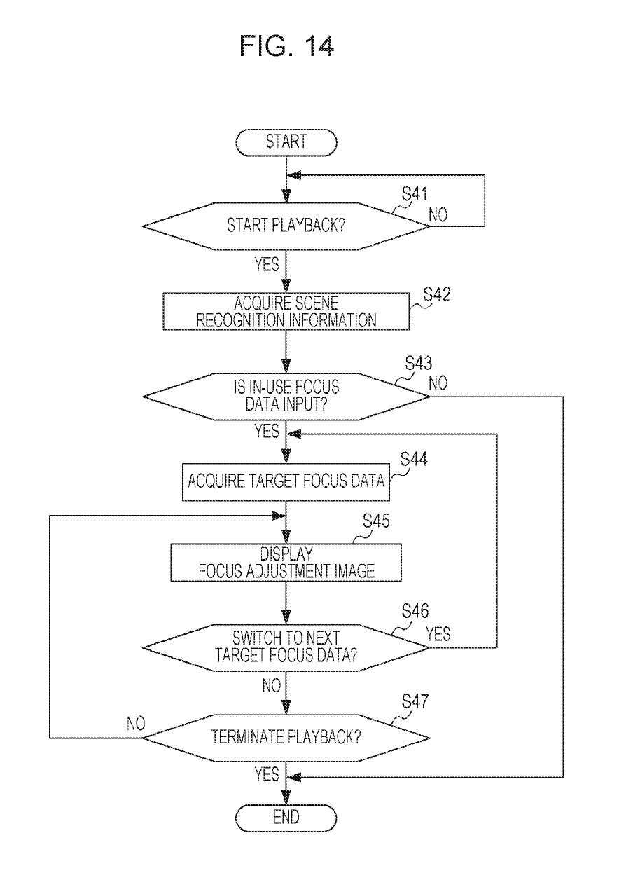

FIG. 14 is a flowchart illustrating the procedure of a target-focus-data playback process performed in the display apparatus 2. In an idle state, the operation receiving unit 251 monitors whether or not an operation for starting playback of target focus data is performed (S41). In the case where the operation receiving unit 251 detects that the operation for starting playback of target focus data has been performed (Yes in S41), the operation receiving unit 251 causes, using the image display unit 255, the display unit 23 to display an operation screen used to receive scene recognition information, and acquires scene recognition information input by a user (S42).

Upon acquiring the scene recognition information, the operation receiving unit 251 notifies the image display unit 255 that playback is to be started and of the scene recognition information. Upon receiving a notification indicating that playback is to be started, the image display unit 255 reads out, from the memory 24, target focus data corresponding to the scene recognition information, and starts playback of the target focus data.

Specifically, upon starting playback of the target focus data, the image display unit 255 confirms whether or not in-use focus data is input from the focus-data acquisition unit 253 (S43). In the case where the image display unit 255 confirms that in-use focus data is input (Yes in S43), thereafter the image display unit 255 acquires in-use focus data at predetermined time intervals. In the case where the image display unit 255 confirms that in-use focus data is not input over a predetermined time period (No in S43), the image display unit 255 terminates the playback process.

The image display unit 255 acquires, in parallel with acquisition of the in-use focus data, target focus data stored in the memory 24 in association with the scene recognition information (S44). Upon acquiring the in-use focus data and the target focus data, the image display unit 255 causes the display unit 23 to display the focus adjustment image 201 including the target-position image 202 and the in-use position image 203 illustrated in FIG. 2A (S45).

Subsequently, in the case where the image display unit 255 receives, from the operation receiving unit 251, a command to switch to the next target focus data according to the order (Yes in S46), the process returns to S44. In S44, the image display unit 255 acquires the next target focus data according to the order, and causes the display unit 23 to display a target-position image 202 corresponding to the acquired target focus data. In the case where, in S46, the image display unit 255 does not receive a command to switch to the next target focus data according to the order (No in S46), the process proceeds to S47. In S47, the image display unit 255 monitors whether an operation for terminating the playback is performed (S47). Until the operation for terminating the playback is detected, the processing from S45 to S46 is repeated.

### [Procedure of Playback Process in Display Apparatus 2 (Modification)]

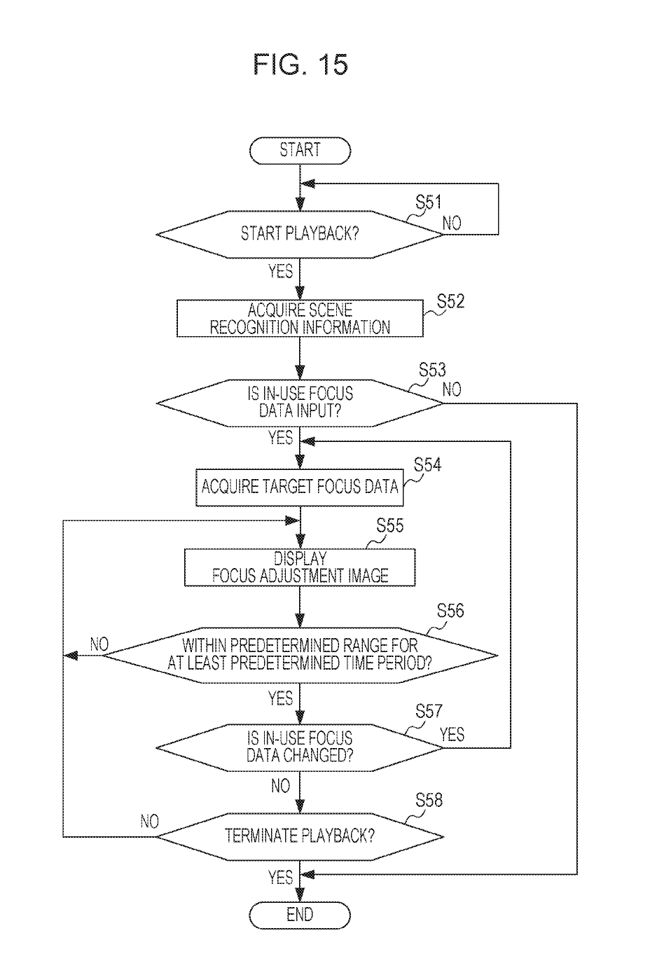

FIG. 15 is a flowchart illustrating a modification of the procedure of a target-focus-data playback process performed in the display apparatus 2. Since S51 to S55 are the same as S41 to S45 of the flowchart illustrated in FIG. 14, description thereof will be omitted.

After displaying a focus adjustment image 201 in S55, the image display unit 255 confirms whether or not the state in which an in-use focus position is included in a predetermined range with respect to a target focus position continues for at least a predetermined time period (S56). For example, the image display unit 255 confirms whether or not the state in which the in-use focus position matches the target focus position for at least a predetermined time period.

In the case where the image display unit 255 determines that the in-use focus position is changed in a short period of time and the state in which the in-use focus position is included in the predetermined range with respect to the target focus position does not continue (No in S56), the process returns to S55. In S55, the image display unit 255 keeps updating, in accordance with in-use focus data, an in-use position image 203 without changing the target-position image 202. In the case where the image display unit 255 determines that the state in which the in-use focus position is included in the predetermined range continues (Yes in S56), the image display unit 255 confirms whether or not the in-use focus data is changed thereafter (S57).

In the case where the in-use focus data is changed, it is considered that a user has performed an operation for changing the focus position. In the case where the image display unit 255 determines that the in-use focus data is changed (Yes in S57), the process returns to S54. The image display unit 255 acquires new target focus data (S54), and changes the target-position image 202 in the focus adjustment image 201 (S55).

As a result, the image display unit 255 is able to update the target-position image 202 in synchronization with an operation performed to change the focus position by a user. Consequently, even in the case where a timing at which the focus position is changed at the time of an image-capturing rehearsal does not match a timing at which the focus position is changed at the time of actual image capturing, switching from one target-position image 202 to another is able to be performed at an appropriate timing. Note that in the case where the image display unit 255 determines in S57 that the in-use focus data is not changed (No in S57), the process proceeds to S58. In S58, the image display unit 255 monitors whether an operation for terminating the playback is performed. Until the operation for terminating the playback is detected, the processing from S55 to S57 is repeated.

### [Advantageous Effects According to Fourth Embodiment]

As described above, in an image capturing system S according to the fourth embodiment, the focus-data acquisition unit 253 acquires, at the time of recording of target focus data, in-use focus data included in an image signal received from the image capturing apparatus 1, and causes, using the memory controller 254, the memory 24 to store the acquired in-use focus data. Thereafter, at the time of playback of target focus data, the image display unit 255 causes the display unit 23 to display an focus adjustment image 201 including a target-position image 202 and an in-use position image 203, the target-position image 202 being based on target focus data stored in the memory 24, the in-use position image 203 being based on in-use focus data acquired by the focus-data acquisition unit 253. With such a configuration, a user is able to adjust the focus position at the time of actual image capturing while looking at a target-position image 202 indicating the focus position used at the time of an image-capturing rehearsal, whereby enabling the user to easily adjust the focus position to an appropriate focus position.

### Fifth Embodiment

It is supposed in the first to fourth embodiments that an image capturing apparatus 1 used at a rehearsal is the same as an image capturing apparatus 1 used at actual image capturing. In contrast to this, a fifth embodiment differs from the first to fourth embodiments in that it is supposed that an image capturing apparatus 1 used at a rehearsal is not the same as an image capturing apparatus 1 used at actual image capturing.

In the case where a first image capturing apparatus 1 used at the time of a rehearsal is not the same as a second image capturing apparatus 1 used at actual image capturing, if target focus data based on the focus position used at the time of the rehearsal is used at the time of actual image capturing performed by the second image capturing apparatus 1, there may be a case where focus is not achieved.

Thus, when target focus data is recorded, the focus-data acquisition unit 253 according to the fifth embodiment extracts an image-capturing apparatus ID included in an image signal received from a certain image capturing apparatus 1, and the memory controller 254 causes the memory 24 to store the target focus data in association with the image-capturing apparatus ID. An image-capturing apparatus ID is information for recognizing an image capturing apparatus 1. In the case where the image-capturing apparatus ID acquired by the focus-data acquisition unit 253 from a certain image capturing apparatus 1 when target focus data is played back does not match the image-capturing apparatus ID associated with the target focus data and read out from the memory 24, the image display unit 255 causes the display unit 23 to display warning information.

In addition, in the case where the image-capturing apparatus ID acquired by the focus-data acquisition unit 253 when target focus data is played back does not match the image-capturing apparatus ID associated with the target focus data and read out from the memory 24, the memory controller 254 may cause the memory 24 to store, in association with the image-capturing apparatus ID of the image capturing apparatus 1, in-use focus data indicating the focus position being used in the image capturing apparatus 1 as target focus data. As a result, the display apparatus 2 is able to cause the memory 24 to newly store target focus data at the time when it becomes clear that no target focus data is available for users.

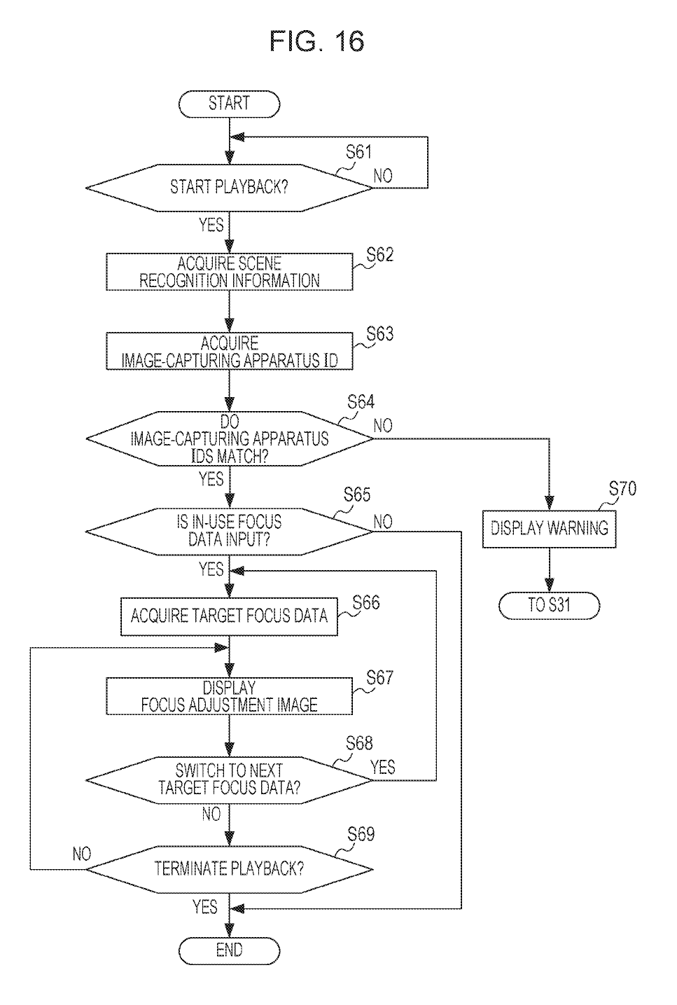

FIG. 16 is a flowchart illustrating a playback process performed in the display apparatus 2 according to the fifth embodiment. The processing in S61 and S62 is the same as the processing in S41 and S42 of the flowchart illustrated in FIG. 14. After S62, the memory controller 254 acquires the image-capturing apparatus ID of the image capturing apparatus 1 via the focus-data acquisition unit 253 (S63). Subsequently, the memory controller 254 determines whether or not the image-capturing apparatus ID acquired in S63 matches an image-capturing apparatus ID stored in the memory 24 in association with the target focus data (S64). In the case where these image-capturing apparatus IDs match (Yes in S64), the display apparatus 2 executes processing from S65 to S69. The processing from S65 to S69 is the same as the processing from S43 to S47 of the flowchart illustrated in FIG. 14.

In the case where the memory controller 254 determines in S64 that the image-capturing apparatus ID acquired during playback of the target focus data does not match the image-capturing apparatus ID stored in the memory 24 (No in S64), the memory controller 254 causes the display unit 23 to display warning information (S70). Thereafter, the process proceeds to the target-focus-data recording process illustrated in FIG. 13 (S31). In S31, the memory controller 254 may cause the memory 24 to store, in association with the image-capturing apparatus ID of the image capturing apparatus 1 being used for image capturing, in-use focus data acquired from the focus-data acquisition unit 253 as target focus data.

### [Advantageous Effects According to Fifth Embodiment]

As described above, the display apparatus 2 according to the fifth embodiment stores the image-capturing apparatus ID of an image capturing apparatus 1 in the memory 24 in association with target focus data. In the case where the image-capturing apparatus ID of an image capturing apparatus 1 that has acquired in-use focus data when target focus data is played back matches an image-capturing apparatus ID stored in the memory 24, the image display unit 255 causes the display unit 23 to display a focus adjustment image 201. In the case where these image-capturing apparatus IDs do not match, the memory controller 254 causes the memory 24 to store, in association with the image-capturing apparatus ID, the in-use focus data acquired by the focus-data acquisition unit 253, the in-use focus data being stored as target focus data. As a result, in the case where a first image capturing apparatus 1 used at the time of a rehearsal is not the same as a second image capturing apparatus 1 used at actual image capturing, image capturing performed by a user in a state in which focus is not achieved may be prevented using a focus adjustment image 201.

### Sixth Embodiment

In the first, second, fourth, and fifth embodiments, the display apparatus 2 displays a target focus position and an in-use focus position. In contrast to this, a sixth embodiment differs from the first, second, fourth, and fifth embodiments in that the image capturing apparatus 1 displays a target focus position and an in-use focus position on the display unit 15.

FIG. 12 is a diagram illustrating the configuration of an image capturing apparatus 1 according to the sixth embodiment. The image capturing apparatus 1 illustrated in FIG. 12 differs from the image capturing apparatus 1 illustrated in FIG. 3 in that the image capturing apparatus 1 illustrated in FIG. 12 includes a memory controller 175. In addition, the image capturing apparatus 1 illustrated in FIG. 12 differs from the image capturing apparatus 1 illustrated in FIG. 3 in that the image-signal generation unit 174 causes the display unit 15 to display not only an image based on image data but also a focus adjustment image 201, which is superimposed on the image based on the image data. The focus adjustment image 201 includes a target-position image 202 and an in-use position image 203, the target-position image 202 indicating a target focus position, the in-use position image 203 indicating an in-use focus position.

The memory controller 175 has substantially the same function as the memory controller 254 according to the first, second, fourth, and fifth embodiments. For example, the memory controller 175 causes the memory 16 to store, as target focus data, the focus position being used at the time of recording of target focus data. The memory 16 stores a target-focus-position table as illustrated in FIG. 5A or 5B. Similarly to the image display unit 255 according to the first, second, fourth, and fifth embodiments, the image-signal generation unit 174 sequentially reads out target focus positions stored in the memory 16, and causes the display unit 15 to display a target-position image 202 together with an in-use position image 203 based on in-use focus data input from the focus controller 172.

### [Advantageous Effects According to Sixth Embodiment]

As described above, the image capturing apparatus 1 according to the sixth embodiment is able to display, together with the focus position being used in image capturing, a target focus position recorded at the time of recording of target focus data. Consequently, without connecting the image capturing apparatus 1 to the display apparatus 2, a user presets, as a target focus position, the focus position used at the time of an image-capturing rehearsal, and becomes able to easily match the focus position of the image capturing apparatus 1 to the target focus position at the time of actual image capturing.

The present invention is described above using the embodiments; however, the technical scope of the present invention is not limited to the description of the above-described embodiments, and various modifications and changes may be made within the scope of the gist of the present invention.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2015-083834, filed Apr. 16, 2015, and Japanese Patent Application No. 2015-083835, filed Apr. 16, 2015 which are hereby incorporated by reference herein in their entirety.

What is claimed is:

1. A display apparatus, the display apparatus being connectable to an image capturing apparatus, comprising:
a memory controller configured to cause a memory to store a target focus position input by a user, the target focus position being a focus position serving as a target and used when image capturing is performed by the image capturing apparatus;
an in-use-focus-data acquisition unit configured to acquire in-use focus data indicating an in-use focus position being used in image capturing performed by the image capturing apparatus;
an image-data acquisition unit configured to acquire image data generated by the image capturing apparatus capturing an image of a subject using the in-use focus position; and
an image display unit configured to superimpose the target focus position and the in-use focus position on a displayed image based on the image data, and cause a display unit to display the target focus position and the in-use focus position.

2. The display apparatus according to claim 1, wherein
the memory controller causes the memory to store a plurality of target focus positions in association with an order in which the plurality of target focus positions are used in image capturing performed by the image capturing apparatus, the plurality of target focus positions including the target focus position, and
the image display unit causes the display unit to display the plurality of target focus positions in association with the order.

3. The display apparatus according to claim 1, wherein
the memory controller causes the memory to store a plurality of target focus positions in association with time periods elapsed from a reference time, the plurality of target focus positions including the target focus position, and
in a case where a time period elapsed from when display of the target focus position is started on the display unit matches an elapsed time period among the elapsed time periods stored in the memory, the image display unit causes the display unit to display a target focus position associated with the elapsed time period.

4. The display apparatus according to claim 1, wherein
in a case where the in-use focus position is included in a predetermined range with respect to the target focus position, the image display unit enlarges the displayed image and causes the display unit to display the enlarged image.

5. The display apparatus according to claim 4, wherein
the memory controller causes the memory to store, in association with the target focus position, a region to be displayed in an enlarged manner in an image, and
the image display unit enlarges and displays an image, which is included in the displayed image, of the region associated with the target focus position.

6. The display apparatus according to claim 4, wherein
the memory controller causes the memory to store, in association with a time period elapsed from a reference time, a region to be displayed in an enlarged manner in an image, and
the image display unit enlarges and displays an image, which is included in the displayed image, of the region corresponding to an elapsed time period acquired when the in-use focus position becomes included in the predetermined range with respect to the target focus position.

7. A display control method comprising:
acquiring a target focus position input by a user, the target focus position being a focus position serving as a target;
causing a memory to store the acquired target focus position;
acquiring in-use focus data indicating an in-use focus position being used in image capturing performed by the image capturing apparatus;
acquiring image data generated by the image capturing apparatus capturing an image of a subject using the in-use focus position; and
superimposing the target focus position and the in-use focus position on a displayed image based on the image data, and causing a display unit to display the target focus position and the in-use focus position.

8. An image capturing apparatus, the image capturing apparatus capturing images of a subject, comprising:
a memory controller configured to cause a memory to store a target focus position input by a user, the target focus position being a focus position serving as a target and used when image capturing is performed;
an in-use-focus-data acquisition unit configured to acquire in-use focus data indicating an in-use focus position being used in image capturing;
an image-data generation unit configured to generate image data as a result of capturing of an image of the subject, the capturing being performed by the image capturing apparatus using the in-use focus position; and
an image display unit configured to superimpose the target focus position and the in-use focus position on a displayed image based on the image data, and cause a display unit to display the target focus position and the in-use focus position.

9. A display apparatus, the display apparatus being connectable to an image capturing apparatus, comprising:
an image-data acquisition unit configured to acquire image data generated by the image capturing apparatus capturing an image of a subject;
a focus-data acquisition unit configured to acquire first focus data indicating a focus position being used in image capturing performed by the image capturing apparatus;
a memory controller configured to cause a memory to store the first focus data; and
an image display unit configured to cause a display unit to display an image based on the image data, wherein
the focus-data acquisition unit acquires, during image capturing performed by the image capturing apparatus, second focus data indicating a focus position being used in the image capturing apparatus, the image capturing being executed after the memory controller causes the memory to store the first focus data, and
during the image capturing, the image display unit superimposes an image based on the first focus data and an image based on the second focus data on a displayed image based on the image data, and causes the display unit to display the image based on the first focus data and the image based on the second focus data.

10. The display apparatus according to claim 9, wherein
in a case where the focus position being used in the image capturing apparatus is the same for at least a time period corresponding to a predetermined value, the memory controller causes the memory to store the first focus data.

11. The display apparatus according to claim 10, wherein
in a case where the focus position being used in the image capturing apparatus is the same for at least the time period corresponding to the predetermined value, the memory controller causes the memory to store, in association with the focus position, the time period elapsed from a reference time to a setting time of the focus position.

12. The display apparatus according to claim 9, wherein
the focus-data acquisition unit acquires a plurality of pieces of first focus data including the first focus data,
the memory controller causes the memory to store the plurality of pieces of first focus data in association with an order acquired by the focus-data acquisition unit, and
the image display unit causes the display unit to display, in association with the order, images based on the plurality of pieces of first focus data.

13. The display apparatus according to claim 12, wherein
after the image based on the second focus data becomes included in a predetermined range from the image that is based on the first focus data and that the display unit is caused to display, in a case where the image based on the second focus data is moved to outside the predetermined range, the image display unit causes the display unit to display an image based on the next first focus data according to the order.

14. The display apparatus according to claim 12, wherein
among the images that the display unit is caused to display and that are based on the plurality of pieces of first target focus data, the image display unit stops displaying an image based on first target focus data that becomes included in a predetermined range from the image based on the second focus data.

15. The display apparatus according to claim 9, wherein
the memory controller causes the memory to store the first focus data in association with scene recognition information used to recognize a captured scene, and
the image display unit causes the display unit to display a screen used to select, from among a plurality of pieces of scene recognition information stored in the memory and including the scene recognition information, a piece of scene recognition information, and causes the display unit to display first focus data corresponding to the selected piece of scene recognition information.

16. The display apparatus according to claim 9, wherein
the memory controller causes the memory to store the first focus data in association with image-capturing-apparatus identification information used to identify the image capturing apparatus,
the focus-data acquisition unit acquires the image-capturing-apparatus identification information from the image capturing apparatus, and
in a case where the image-capturing-apparatus identification information acquired by the focus-data acquisition unit during image capturing executed after the memory controller causes the memory to store the first focus data does not match image-capturing-apparatus identification information associated with the first focus data and read out from the memory, the image display unit causes the display unit to display warning information.

17. The display apparatus according to claim 16, wherein
in a case where the image-capturing-apparatus identification information acquired by the image-data acquisition unit from the image capturing apparatus does not match image-capturing-apparatus identification information associated with the first focus data and read out from the memory, the memory controller causes the memory to store, in association with the image-capturing-apparatus identification information of the image capturing apparatus, focus data indicating a focus position being used in the image capturing apparatus as the first focus data.

18. A display control method comprising:
acquiring image data generated by an image capturing apparatus capturing an image of a subject;
acquiring first focus data indicating a focus position being used in image capturing performed by the image capturing apparatus;
causing a memory to store the first focus data;
causing a display unit to display an image based on the image data;
acquiring second focus data indicating a focus position being used in the image capturing apparatus during image capturing performed by the image capturing apparatus, the image capturing being executed after the first focus data is caused to be stored in the memory; and
during the image capturing, superimposing an image based on the first focus data and an image based on the second focus data on a displayed image based on the image data, and causing the display unit to display the image based on the first focus data and the image based on the second focus data.

19. An image capturing apparatus comprising:
an image-data generation unit configured to generate image data by capturing an image of a subject;
a focus-data acquisition unit configured to acquire first focus data indicating a focus position being used in image capturing;
a memory controller configured to cause a memory to store the first focus data; and
an image display unit configured to cause a display unit to display an image based on the image data, wherein
the focus-data acquisition unit acquires second focus data indicating a focus position being used in the image capturing apparatus during image capturing performed by the image capturing apparatus, the image capturing being executed after the memory controller causes the memory to store the first focus data, and
during the image capturing, the image display unit superimposes an image based on the first focus data and an image based on the second focus data on a displayed image based on the image data, and causes the display unit to display the image based on the first focus data and the image based on the second focus data.
